(19) United States
(12) Patent Application Publication
(10) Pub. No.: US 2014/0054916 A1
(43) Pub. Date: Feb. 27, 2014

(54) Composite Commercial Walk-In Van Body

(71) Applicants: John E. Knudtson, Granger, IN (US); Timothy F. Marling, Granger, IN (US); Eugene A. Dylewski, II, Granger, IN (US)

(72) Inventors: John E. Knudtson, Granger, IN (US); Timothy F. Marling, Granger, IN (US); Eugene A. Dylewski, II, Granger, IN (US)

(73) Assignee: Spartan Motors, Inc., Charlotte, MI (US)

(21) Appl. No.: 14/020,362

(22) Filed: Sep. 6, 2013

Related U.S. Application Data
(63) Continuation of application No. PCT/US2012/028085, filed on Mar. 7, 2012.
(60) Provisional application No. 61/450,018, filed on Mar. 7, 2011.

(51) Int. Cl. B60P 3/00; B62D 65/02; B62D 33/06; B62D 29/04; B62D 33/04

(52) U.S. Cl. CPC B60P 3/007; B62D 29/045; B62D 33/046; B62D 33/06; B62D 65/02
USPC 296/24.3; 29/897.2

(57) ABSTRACT

A composite commercial walk-in van body is constructed via lightweight, composite structures. A composite floor structure having integral logistic tracks are joined to composite sidewalls that include integral rub rails that also integrally formed logistic tracks on an interior thereof. Pigment molded lower body panels that extend beyond the sidewalls are fully replaceable to enhance durability and maintenance of the walk-in van body. A one-piece molded roof eliminates leaks. Any necessary rivets are captured so as to prevent any wet-to-dry surface penetration. An easily accessible washer fluid and brake fluid reservoir aid in the maintenance and operability of the walk-in van body. Such elements contribute to substantial weight reduction, and increase in durability, functionality, and fuel economy of walk-in vans utilizing such a composite body.

### CROSS-REFERENCE TO RELATED PATENT APPLICATIONS

This patent application is a continuation of pending PCT Application No. PCT/US2012/028085, filed Mar. 7, 2012, which claims the benefit of U.S. Provisional Application No. 61/450,018, filed Mar. 7, 2011, the entire teachings and disclosure of which are incorporated herein by reference thereto.

### FIELD OF THE INVENTION

This invention generally relates to commercial vehicles, and more particularly to class 3 commercial vehicle bodies for walk-in commercial vans.

### BACKGROUND OF THE INVENTION

Commercial vehicles, such as walk-in vans, parcel delivery vans, as well as truck bodies and specialty upfit vehicles for the parcel delivery, baking and snack food, textile, utilities, emergency response, mobile sales and maintenance industries must have a long life and low cost of ownership. Indeed, such commercial vehicles must be designed for hundreds of stops per day, be rugged and repairable to increase actual service life, and provide a safe and productive work environment for the driver and handling personnel.

Unlike other commercial vehicles, walk-in vans provide a low step-in height at the cab doors and rear door, as well as wide cab doors, to provide optimum entry and exit capacity. Full stand-up height in cab and cargo areas in such walk-in vans offers a superior vehicle for an ergonomical work space. When equipped with a traditional bulkhead and door, walk-in vans provide instant access from the cab to the cargo area, allowing for safer cargo delivery versus a cube van. Further, the lightweight aluminum construction of such walk-in vans provides a durable, rust-free body with lighter overall weight for increased payload capacity.

While such traditional walk-in vans provide significant advantages over other commercial vehicles for the markets they serve, the continued rise in fuel cost, service, maintenance, and repair costs, have increased the cost of ownership. Indeed, while the use of lightweight aluminum for the body of the walk-in vans provided significant improvement in terms of repair and replacement costs due to rust compared to prior constructions, the changing composition of ice melting chemicals used on city streets and highways on which such walk-in vans drive has resulted in pitting and corrosion on the aluminum body construction. This further increases the repair costs of such vans, and may require that application of new corrosion coatings or shielding of the aluminum, at a substantial cost, to protect against such pitting and corrosion.

Additionally, the use of aluminum panels to construct the sidewalls of the walk-in vans requires that such individual panels be riveted to steel vertical interior studs with buck rivets to form the sidewall. The rub rails, meant to protect the sidewalls from damage due to scraping against other objects, must also be riveted onto the sidewall structure. Such construction and riveting not only increases the initial construction cost, but also increases the repair cost of such sidewalls once damaged. The buck rivets also provide a potential leak path from the exterior to the interior of the walk-in van since they traverse the wet-to-dry barrier of the sidewall into the cargo compartment.

In view of the above, there is a need for a commercial walk-in van body that reduces the total cost of operation by reducing fuel consumption and carbon footprint, that provides a rugged commercial work truck, and that focuses on operator safety and productivity. Embodiments of the invention provide such a walk-in van body. These and other advantages of the invention, as well as additional inventive features, will be apparent from the description of the invention provided herein.

### BRIEF SUMMARY OF THE INVENTION

In view of the above, embodiments of the present invention provide new and improved commercial vehicle bodies that overcome one or more of the problems existing in the art. More particularly, embodiments of the present invention provide new and improved commercial walk-in van bodies that overcome one or more of the problems existing in the art. Still more particularly, embodiments of the present invention provide a new and improved walk-in van body that has a reduced total cost of operation due to the reduced fuel consumption and carbon footprint of a walk-in van constructed with such a body, its rugged commercial body, and its operator safety and productivity gains enabled by its ergonomics, functionality, and design flexibility.

A lightweight commercial walk-in van body with an aerodynamic design (13% more aerodynamic in one embodiment) constructed in accordance with one embodiment of the present invention aids in the delivery of 35% better fuel-efficiency, providing a new definition of safety, performance and cost-effectiveness. Improved cab ergonomics of one embodiment of the present invention delivers faster entry/egress for the walk-in van operator, providing a 1.5 hours per day productivity gain.

Corrosion-resistant, long-life composite materials utilized in one embodiment saves 600 lbs per vehicle. Body on frame construction of one embodiment provides less costly accident repairs compared to automotive unibody designs used in prior walk-in vans. In one embodiment, the lower body panels are designed for quick removal and replacement to further reduce repair and maintenance time and expense.

To improve operator safety, an embodiment of the present invention may include integrated entry hand rails, a backup camera system, high visibility steps with slip-resistant carbide tread, and 13″ more aisle width than a cargo van (50% wider). Embodiments also provide the best-in-class visibility for improved low-speed maneuverability.

Embodiments of the present invention also include best-in-class sustainability by aiding in a reduced carbon footprint (carbon dioxide emissions) of up to 11 tons per year per vehicle, by providing numerous body components made from recycled material, and by providing a composite construction to minimizes underbody corrosion.

The wider and taller modular cargo area of three embodiments of the present invention provides 450, 540 or 630 cubic feet of storage and offers a choice of vocational packages specifically designed for functionality. With three embodiment of vehicles ranging from 10 to 14 feet in length and a payload capacity of up to 4,800 pounds, productivity in delivery or work truck applications is greatly increased.

Preferred embodiments of the present invention are commercial vehicles with flat, vertical sidewalls, sliding cab doors, have several rear door options, and are designed for walk-in van duty cycles. Such embodiments, unlike current walk-in vans, also provide improved exterior appearance, improved cab interior fit & finish, molded, impact resistant lower and rear body panels, composite floor and sidewall panels, and a large curved windshield. The material used in embodiments of the present invention are chosen based on at least one of durability/impact resistance, safety & functionality, corrosion resistance, cost and weight, manufacturability and paintability, appearance, reparability/replaceability, recycleability, and thermal and sound insulation properties.

One of the benefits provided by embodiments of the present invention is a miles per gallon (MPG) improvement from the enhanced aerodynamics of such embodiments. Specifically, MPG improvement is roughly equal to one half of the percentage reduction in drag coefficient. In certain embodiments the coefficient of drag (Cd) has been reduced from 0.61 for typical walk-in vans to 0.53. This 13% improvement, could result in a 6.5% MPG increase for commercial walk-in vans constructed using such a body.

Another of the MPG improvements provided by embodiments of the present invention is from weight reduction. In stop-and-go applications such as with walk-in vans, MPG improvement is roughly equal to one half of the percentage of weight reduction. Because embodiments of the present invention utilize lightweight composite panels for the floor and sidewalls, the body is much lighter than prior walk-in van bodies.

Body durability of embodiments of the present invention also reduces the cost of ownership. Unlike cargo vans that are made of thin-gauge welded steel bodies mounted on light-weight frames, embodiments of the present invention utilize a body that is designed for a commercial truck application. Such embodiments utilize impact resistance urethane rear and lower exterior panels, rear spring bumper and energy absorbing side bumpers, one-piece molded roof to eliminate leaks, LED interior and exterior lights (all except headlights), and doors and hardware designed for the application.

With regard to service and repair, embodiments of the present invention utilize a body designed as a true commercial vehicle, allowing quick and easy body repairs to put the vehicle back in original condition. Part of this is the vehicle repair procedures. In embodiments of the present invention, the body panels are designed for quick removal and replacement. Indeed, the replacement panels are supplied in final color to further reduce the time and expense of such repair. With regard to the maintenance aspects of these embodiments, under-hood maintenance points are organized and accessible. Indeed, the hood of the vehicle extends the entire width of the front end for maximum access. Further, the hood is designed for quick removal. The instrument panel allows quick access to under-dash components as well. Wire routing and connections are highly accessible, which also reduces the cost of maintenance.

Embodiments of the present invention also provide enhanced ergonomics and functionality. In a fleet delivery walk-in van application, such operator ergonomics when the vehicle is stopped is just as important as when it is moving. Driver safety and ergonomics are enhanced in embodiments of the present invention by improving driver movement in and around the van, driver visibility, the placement and design of driver controls, improved interior styling and fit and finish, reduced interior sound level, and simplified instruments and controls. Indeed, embodiments of the present invention approach the design of the cab as an office. The driver can walk in and out of the cab in an upright position, and has access to cargo area from driver seat. Preferred embodiments also approach the cargo compartment as a work area. Such embodiments provide stand-up height in the cargo area, a wider and taller cargo area, has multiple rear door options, and sliding doors in the cab, which eliminates the need for a side door in the cargo compartment. The design flexibility of embodiments of the present invention is also enhanced through multiple rear door options, including roll-up doors, 270° twin-swing doors, twin side-sliding doors, etc.

Design Flexibility is also enhanced by inclusion of logistic tracks integrated into body design which enable installation of custom cargo interior packages, such as shelves, wire racks, etc. Such logistic tracks allow other package delivery cargo modules, such as printer stands, spare tire mounts, hazardous goods restraints, winter driving ballast, etc.

In certain embodiments, a composite commercial walk-in van body is provided. The composite commercial walk-in van body includes a cab and a cargo area adjoining the cab which is accessible therethrough. The cargo area includes a composite cargo floor. A lower composite sidewall is coupled to the composite cargo floor. An upper composite sidewall is coupled to the lower composite sidewall by a rubrail structure. A one-piece molded roof is coupled to the upper composite sidewall.

In certain embodiments, the composite cargo floor and a lower composite sidewall are coupled to one another via a lower bracket structure. The lower bracket structure may be formed as a multi-piece assembly comprising a floor bracket, a sidewall exterior bracket coupled to the floor bracket, and a sidewall interior bracket coupled to the sidewall exterior bracket. A portion of the composite cargo floor is received in a channel of the floor bracket. The portion of the composite cargo floor is fixed within the channel with an adhesive that acts as a sealant.

In certain embodiments, the sidewall interior bracket and the sidewall exterior bracket are coupled to one another to form a channel. A portion of the lower composite sidewall is received within the channel. The portion of the lower composite sidewall is fixed within the channel using an adhesive that acts as a sealant.

In certain embodiments, the floor bracket includes an inner and an outer upstanding wall arranged in a posed space relation to form a pocket therebetween. A portion of the sidewall exterior bracket and a portion of the sidewall interior bracket cover an opening of the pocket to isolate the pocket from an exterior environment of the van body. The sidewall exterior bracket is mounted to the outer upstanding wall using at least one outer rivet. The sidewall interior bracket is mounted to the inner upstanding wall using at least one inner rivet. Each of the at least one outer and inner rivets extend into the pocket formed between the inner and outer upstanding walls.

In certain embodiments, the rubrail structure is a multi-piece structure comprising an interior bracket and a rubrail. The interior bracket and rubrail are coupled to one another to form upper and lower channels. The lower composite sidewall is received within the lower channel. The upper composite sidewall is received within the upper channel. The lower composite sidewall is fixed within the lower channel with an adhesive that acts as a sealant. The upper composite sidewall is fixed within the upper channel with an adhesive that acts as a sealant.

In certain embodiments, the rubrail includes at least one pocket which is isolated from an exterior of the van body. The interior bracket is joined to the rubrail using at least one rivet. The at least one rivet extends into the at least one pocket of the rubrail.

In certain embodiments, the one-piece molded roof is coupled to the upper sidewall via an upper bracket structure that is a multi-piece component comprising a corner bracket, a roof/sidewall interior bracket coupled to the corner bracket, and a roof/sidewall exterior bracket coupled to the roof/sidewall interior bracket. The corner bracket includes a channel for receiving at least one support beam positioned underneath the one-piece molded roof. The roof/sidewall interior bracket and roof/sidewall exterior bracket are coupled to one another to form a channel for receiving the upper sidewall. The upper sidewall is fixed within the channel with an adhesive that acts as a sealant. The one-piece molded roof is sealed to the upper bracket structure using a vutyl rope.

In certain embodiments, the composite cargo floor is formed from a corrosive resistant material and has an upper and a lower surface. The upper surface faces the cargo area. The lower surface is exposed to an exterior of the van body on an underside thereof. The composite cargo floor is a resin infused foam-core construction having fiberglass crossbeams. The upper surface of the composite cargo floor is textured for slip resistance.

In certain embodiments, the upper and lower sidewalls comprise a honeycomb core that is resin infused.

In certain embodiments, a composite commercial walk-in van body is provided. A composite commercial van body according to this embodiment includes a cab having an interior operator space. A cargo area is adjoined to the cab and is accessible therethrough via a bulkhead doorway. A bulkhead door is mounted within said doorway and slideable relative thereto. At least one vehicle fluid reservoir port is accessible from within the cab.

In certain embodiments, the interior operator space has an overall height of about five (5) feet to about seven (7) feet. The bulkhead door is mechanically coupled to an actuation mechanism. The actuation mechanism is in electronic communication with the receiver. The receiver is configured to receive an actuate signal to actuate the actuation mechanism and selectively and automatically open and close the bulkhead door.

In certain embodiments, a composite commercial walk-in van body is provided. A composite commercial walk-in van body according to this aspect includes a cab. A cargo area adjoins the cab and is accessible therethrough. The cargo area includes a cargo floor. A lower sidewall is coupled to the cargo floor by a lower bracket structure. A upper sidewall is coupled to the lower sidewall by a rubrail structure. A roof is coupled to the upper sidewall by an upper bracket structure. At least one of the lower bracket structure, rubrail structure, and upper bracket structure comprising integral logistic track formed therein.

In certain embodiments, the integral logistic track comprises a raceway and a fastener slideable within the raceway. The fastener is configured for adjustable fixed positioning within the raceway.

In certain embodiments, a method for assembling a composite commercial walk-in van body cargo area is provided. The method according to this embodiment includes mounting a composite cargo floor to a lower bracket structure using an adhesive. The method also includes mounting a lower composite sidewall to the lower bracket structure using an adhesive at a first end of the lower composite sidewall. The method also includes mounting a rubrail structure to the lower composite sidewall at a second end opposite the first end of the lower composite sidewall using an adhesive. The method also includes mounting a first end of an upper composite sidewall to the rubrail structure using an adhesive. The method also includes mounting a second end of the upper composite sidewall to an upper bracket structure using an adhesive. The method also includes sealingly installing a one-piece molded roof to the upper bracket structure.

In certain embodiments, the method additionally includes assembling the lower bracket structure by forming a rivet connection between an interior sidewall bracket to a floor bracket and by forming a rivet connection between an exterior sidewall bracket to the floor bracket. Each of the rivet connections is isolated from an exterior of the cargo area.

In certain embodiments, the method also includes assembling the rubrail structure by forming a rivet connection between an interior bracket and a rubrail. The rivet connection is isolated from an exterior of the cargo area.

In certain embodiments, the method also includes assembling the upper bracket structure by forming a rivet connection between a corner bracket and an interior roof/sidewall bracket and by forming a rivet connection between the interior roof/sidewall bracket and an exterior roof/sidewall bracket. Each of the rivet connections is isolated from an exterior of the cargo area.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front, right side illustration of an embodiment of a commercial walk-in van constructed in accordance with the teachings of the present invention;

FIG. 2 is a right side illustration of the embodiment of the commercial walk-in van of FIG. 1 constructed in accordance with the teachings of the present invention;

FIG. 3 is a front, left side illustration of the embodiment of the commercial walk-in van of FIG. 1 constructed in accordance with the teachings of the present invention;

FIG. 4 is a rear, left side illustration of the embodiment of the commercial walk-in van of FIG. 1 constructed in accordance with the teachings of the present invention

FIG. 5 is a front, right side illustration of another embodiment of a commercial walk-in van constructed in accordance with the teachings of the present invention;

FIG. 6 is a front, left side illustration of the embodiment of the commercial walk-in van of FIG. 5 constructed in accordance with the teachings of the present invention;

FIG. 7 is a rear, left side illustration of the embodiment of the commercial walk-in van of FIG. 5 constructed in accordance with the teachings of the present invention;

FIG. 8 is an illustration of an aerodynamic analysis model of an embodiment of a commercial walk-in van constructed in accordance with the teachings of the present invention;

FIG. 9 is a left side illustration of a ten foot cargo length embodiment of a commercial walk-in van constructed in accordance with the teachings of the present invention;

FIG. 10 is a left side illustration of a twelve foot cargo length embodiment of a commercial walk-in van constructed in accordance with the teachings of the present invention;

FIG. 11 is a left side illustration of a fourteen foot cargo length embodiment of a commercial walk-in van constructed in accordance with the teachings of the present invention;

FIG. 12 is a partial exploded view of an embodiment of a commercial walk-in van constructed in accordance with the teachings of the present invention illustrating ability to replace lower, front, and rear cladding, front facie, grill, and hood;

FIG. 13 is a front view illustration of an embodiment of a commercial walk-in van constructed in accordance with the teachings of the present invention illustrating accesses to the engine compartment thereof;

FIG. 14 is an isometric cross-section illustration of composite side wall and floor sections constructed in accordance with the teachings of the present invention for use in an embodiment of a commercial walk-in van of the present invention;

FIG. 15 is an isometric sectional view of an embodiment of an attachment mechanism for the composite floor and composite side wall of an embodiment of a commercial walk-in van constructed in accordance with the present invention forming an integrated logistic track and lower cladding attachment;

FIG. 16 is cross-sectional view of an embodiment of an attachment mechanism for the composite floor and composite side wall of an embodiment of a commercial walk-in van constructed in accordance with the present invention forming an integrated logistic track and lower cladding attachment;

FIG. 17 is an isometric sectional view of an embodiment of an attachment mechanism for the composite lower side wall and composite upper side wall of an embodiment of a commercial walk-in van constructed in accordance with the present invention forming an integrated rubrail and logistic track;

FIG. 18 is an cross-sectional view of an embodiment of an attachment mechanism for the composite lower side wall and composite upper side wall of an embodiment of a commercial walk-in van constructed in accordance with the present invention forming an integrated rubrail and logistic track;

FIG. 19 is an isometric sectional view of an embodiment of an attachment mechanism for the composite upper side wall and roof of an embodiment of a commercial walk-in van constructed in accordance with the present invention forming integrated logistic tracks;

FIG. 20 is an cross-sectional view of an embodiment of an attachment mechanism for the composite upper side wall and roof of an embodiment of a commercial walk-in van constructed in accordance with the present invention forming integrated logistic tracks;

FIG. 21 is an illustration of a cab area for an embodiment of a commercial walk-in van constructed in accordance with the teachings of the present invention;

FIG. 22, is an ergonomic external line of sight design limit illustration for an embodiment of a commercial walk-in van constructed in accordance with the teachings of the present invention;

FIG. 23 is an ergonomic internal line of sight design limit illustration for a cab area of an embodiment of a commercial walk-in van constructed in accordance with the teachings of the present invention;

FIG. 24 is an illustration of a cab area for an embodiment of a commercial walk-in van constructed in accordance with the teachings of the present invention;

FIG. 25 is an illustration of a passenger-side entry into the cab area for an embodiment of a commercial walk-in van constructed in accordance with the teachings of the present invention;

FIG. 26 is a right-side view illustration of an entry into and cab area for an embodiment of a commercial walk-in van constructed in accordance with the teachings of the present invention;

FIG. 27 is an illustration of a cargo area for an embodiment of a commercial walk-in van constructed in accordance with the teachings of the present invention;

FIG. 28 is a rear-view illustration of a cargo area for an embodiment of a commercial walk-in van constructed in accordance with the teachings of the present invention having a roll-up rear door;

FIG. 29 is a rear-view illustration of a cargo area for an embodiment of a commercial walk-in van constructed in accordance with the teachings of the present invention having a pair of 270° swinging rear doors;

FIG. 30 is a rear-view illustration of a cargo area for an embodiment of a commercial walk-in van constructed in accordance with the teachings of the present invention having twin side-sliding rear doors;

FIG. 31 is an illustration of a cargo area for an embodiment of a commercial walk-in van constructed in accordance with the teachings of the present invention;

FIG. 32 is an illustration of a cargo area for an embodiment of a commercial walk-in van constructed in accordance with the teachings of the present invention having a shelving unit installed therein;

FIG. 33 is an illustration of a cargo area for an embodiment of a commercial walk-in van constructed in accordance with the teachings of the present invention having wire racks installed therein;

FIGS. 34-37 are illustrations of a cargo area for an embodiment of a commercial walk-in van constructed in accordance with the teachings of the present invention having different custom vocational packages installed therein; and

FIG. 38 is a rear-view illustration of a cargo area for an embodiment of a commercial walk-in van constructed in accordance with the teachings of the present invention illustrating operator ingress.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

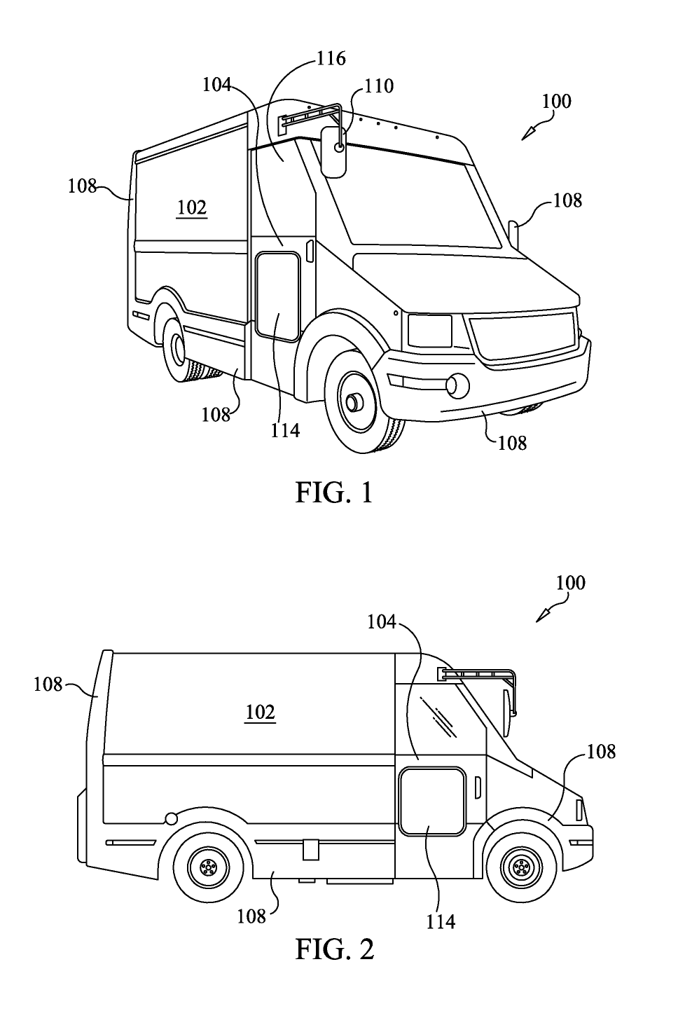

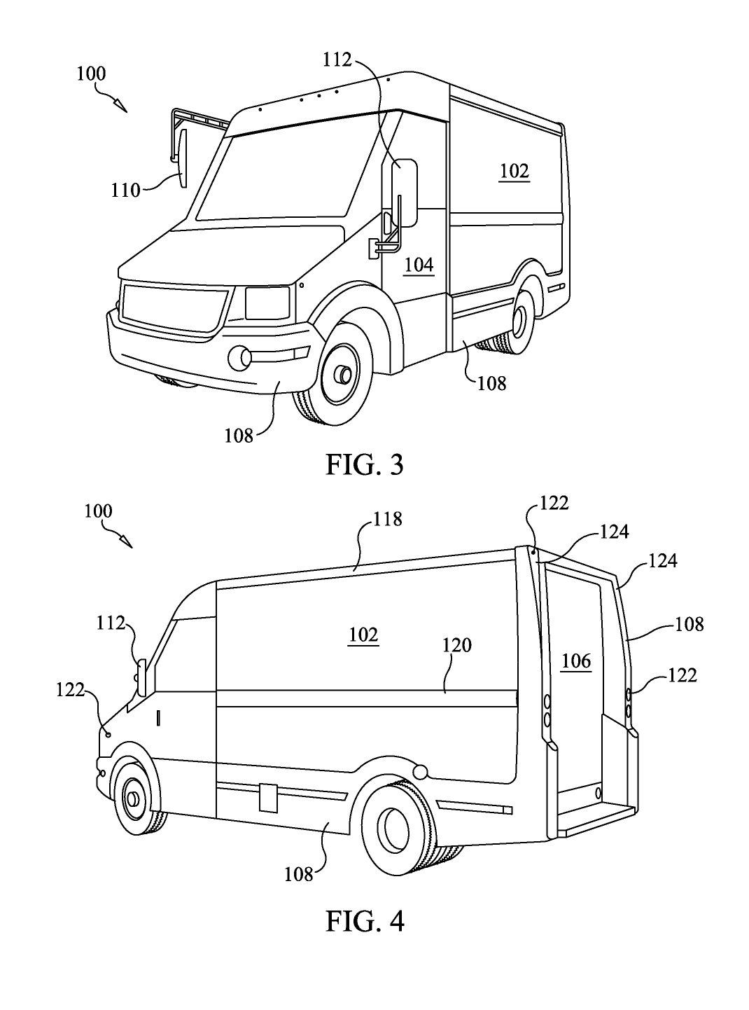

Turning now to the drawings, there is illustrated in FIGS. 1-4 a commercial vehicle utilizing a composite commercial walk-in van body 100 constructed in accordance with the teachings of the present invention. It should be noted, however, that while the following description will describe various embodiments and aspects of various embodiments of the present invention configured as a composite commercial walk-in van, the scope of the present invention is not so limited. Indeed, many of the aspects of the present invention may find applicability in other applications, in other commercial vehicles other than walk-in vans. As such, the following description should be taken by way of example and not by way of limitation.

As may be seen from the embodiment illustrated in FIGS. 1-4, the walk-in van body 100 has flat, vertical sidewalls 102, sliding cab doors 104, and a roll up rear door 106. This embodiment also includes molded, impact resistant lower and rear body panel 108. This embodiment also features a high mount passenger mirror 110 and a low mount driver's mirror 112 and enables nesting of the mirrors 110, 112 to reduce the parking space needed for a fleet of such walk-in vans constructed with the body 100 of the present invention when parked side-by-side. In other words, the walk-in vans may be parked very close to one another, which will result in the passenger side mirror 110 of one walk-in van being positioned over the driver side mirror 112 of the walk-in van next to it.

As may be seen in FIGS. 1 and 2, the sliding passenger side cab door 104 includes a lower glass portion 114 that increases the driver's visibility. Indeed, in one embodiment of the present invention the passenger side upper window 116 may be rolled down into the cab door 104 without obstructing the view through the lower window 114.

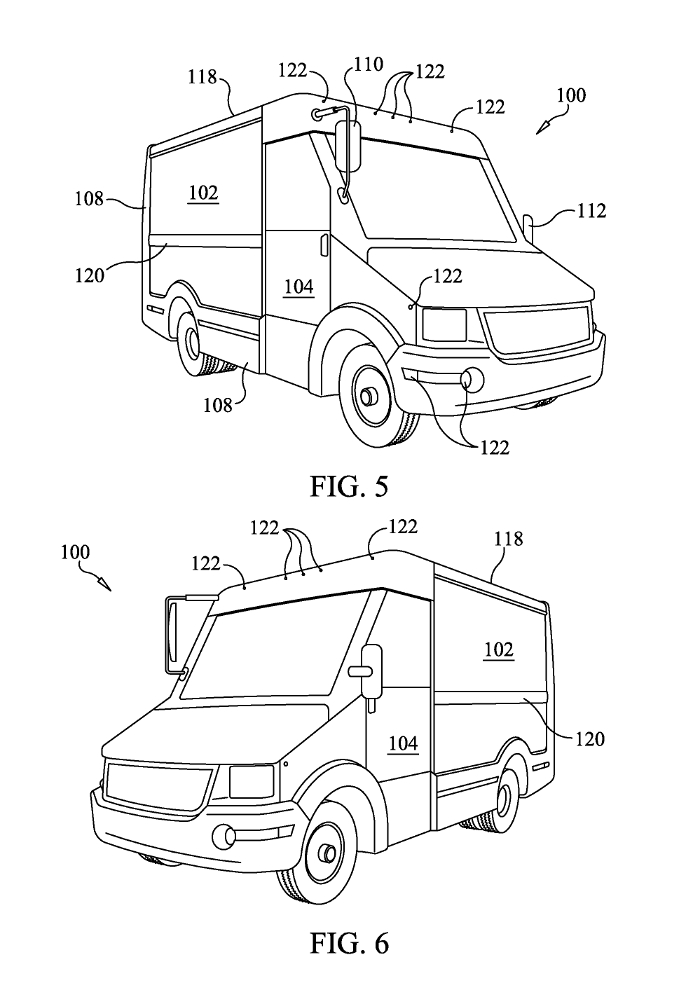

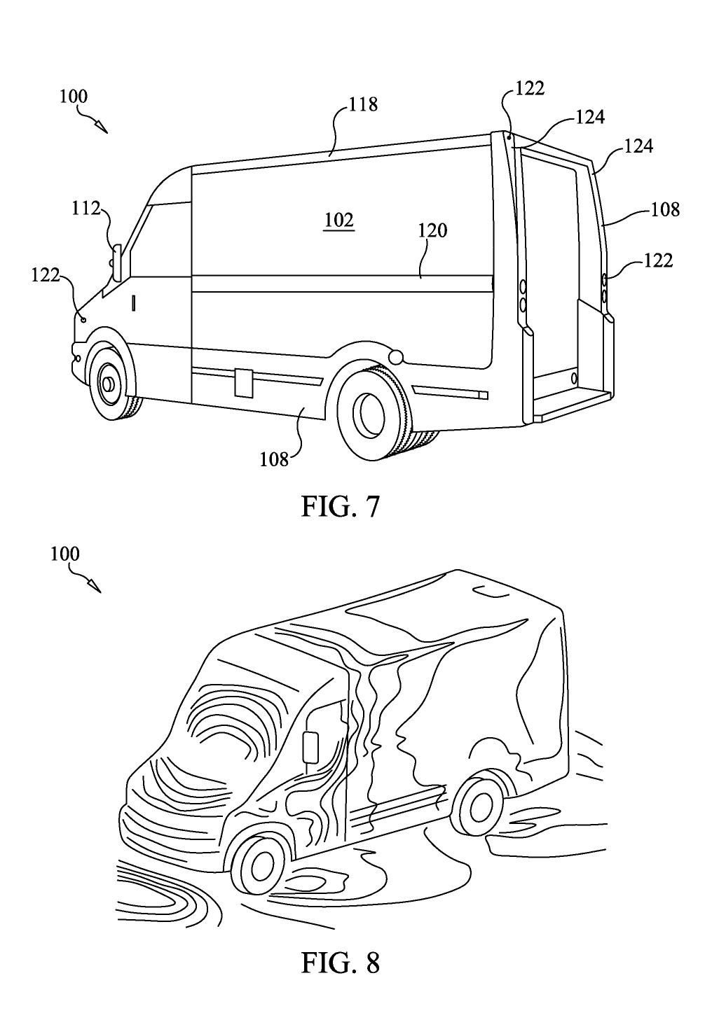

An alternate embodiment of the composite commercial walk-in van body 100 is illustrated in FIGS. 5-7. As may be seen more clearly in this alternate embodiment, the walk-in van body 100 includes a one-piece molded roof 118 to aid in the elimination of leaks into the walk-in van body 100. As may also be seen more clearly in this alternate embodiment, each of the sidewalls 102 include an integral rub rail 120 that not only aids in the stability of the vertical sidewall 102, but also helps protect the sidewall 102 from damage from contact with other surfaces. As may also be seen, certain embodiments of the walk-in van body 100 of the present invention include LED exterior light 122 (all except headlights). Indeed, as may be best seen from FIG. 7, the rear body panels 108 include an angled portion 124 at the upper end thereof so that the LED light 122 positioned thereat is visible both from a side of the walk-in van body 100, as well as directly from the rear of the walk-in van body 100. Advantageously, this eliminates the need for two LEDs on each upper corner of the rear of the vehicle while still meeting safety regulations mandating that such illumination be visible from the side and the rear of the walk-in van body 100.

As will be apparent to those of ordinary skill in the commercial vehicle art, each of the embodiments illustrated in FIGS. 1-4 and 5-7 are substantially more aerodynamic than prior commercial walk-in vans. Indeed, as may be seen from the aerodynamic model analysis illustrated in FIG. 8, the coefficient of drag (C_{d}) has been reduced from 0.61 for a typical commercial walk-in van to 0.53. This 13% improvement could result in a 6.5% fuel efficiency (miles per gallon or MPG) increase because an MPG improvement is roughly equal to one-half of the percentage reduction in drag coefficient.

Further, and as will be discussed in detail below, in stop-and-go applications typical for a commercial walk-in van, an MPG improvement is also roughly equal to one-half of the percentage of weight reduction. As such, lightweight materials are used in the construction of embodiments of the walk-in van body 100 of the present invention. These lightweight materials include composite panels used for the construction of the sidewalls 102 and flooring of the cargo compartment of the walk-in van body 100, as well as usage of sheet mold composite (SMC) for structural parts in the hood, tow kicks in the cab, interior wheel wells, etc. The result of the usage of such lightweight materials and composite panels result in a body that is much lighter than prior commercial walk-in van bodies, which provide a significant weight reduction and therefore MPG improvement. As another advantage, these sidewalls 102 and the lower and rear body panels 108, as well as the other composite body components can be molded and subsequently assembled in their final color. As one example, the sidewalls 102 can incorporate a gel coat outer surface which those skilled in the art will recognize is thicker and more durable than conventional paint.

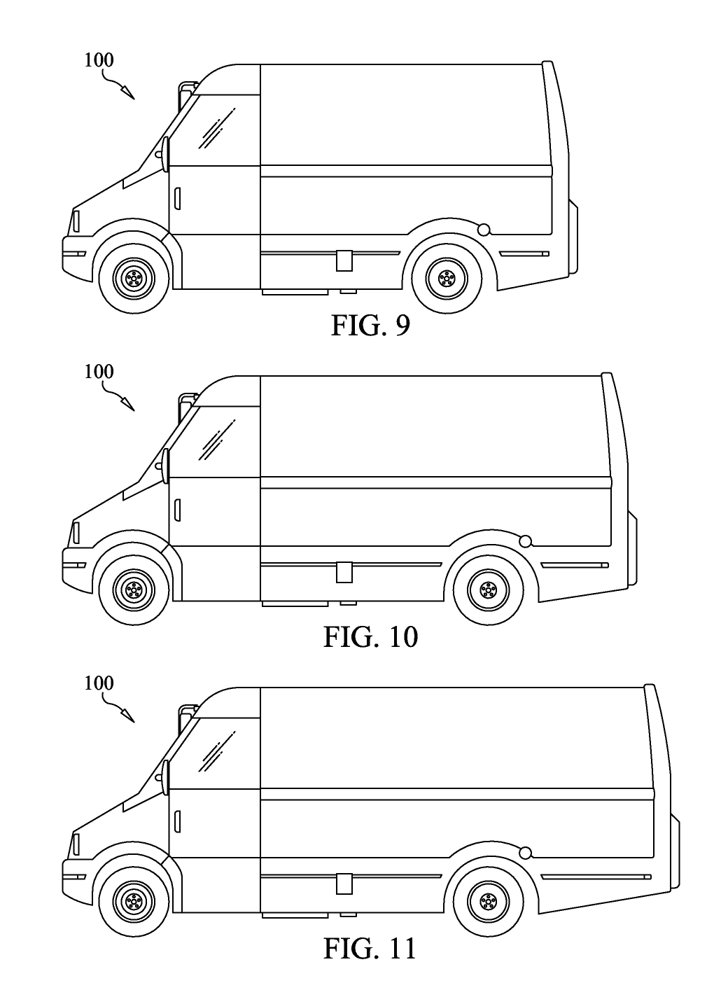

As shown in FIGS. 9-11, the commercial walk-in van body 100 may come in various sizes to accommodate different cargo carrying capacities. As shown in FIG. 9, the walk-in van body 100 includes a cargo area having a length of approximately 10 feet to carry approximately 450 cubic feet of cargo volume. FIG. 10 illustrates an embodiment having an approximately 12 foot long cargo area and accommodation of a longer wheel base enabling approximately 540 cubic feet of cargo volume. FIG. 11 illustrates an embodiment having a cargo area length of approximately 14 feet, which enables a cargo volume of approximately 630 cubic feet in the configuration shown.

Indeed, while not illustrated in FIGS. 9-11, six different embodiments are envisioned for commercial production that will take advantage of the three different lengths of cargo area with two different heights available, e.g. 2,030 millimeter and 1,880 millimeter inside height. Each of the six embodiments would share a single width of the cargo area of approximately 2,100 millimeters inside. However, such lengths, widths, and heights are not limiting to the present invention, but merely illustrate specific embodiments of particular applicability to current commercial needs.

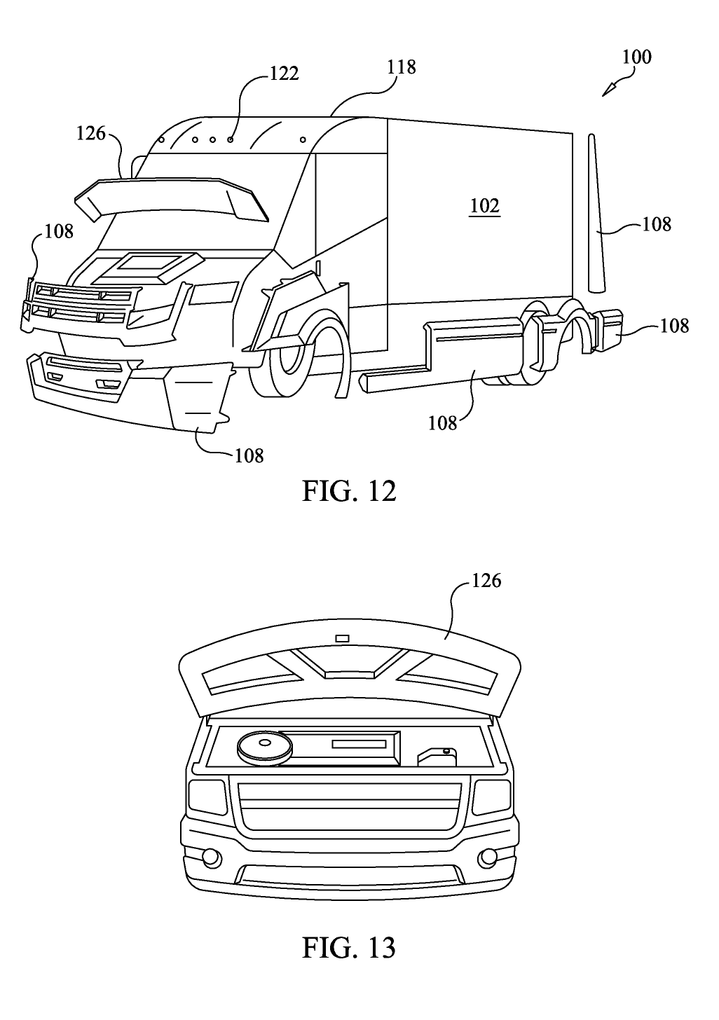

As introduced briefly above, embodiments of the present invention utilize molded, impact resistant lower and rear body panels 108 in order to increase the durability, reparability, replaceability, and reduce the weight of the commercial walk-in van body 100. These various lower and rear body panels 108 may be seen in the exploded isometric illustration of FIG. 12. As may be seen, these lower and rear body panels 108 are molded to project outwardly from the sidewalls 102 so as to reduce the likelihood of impact damage on the sidewalls themselves from contact with other surfaces, vehicles, loading docks, etc. Indeed, if any impact damage is sustained by the lower and rear body panels, they may be easily removed and replaced as part of the repair operation, as opposed to requiring the repair or replacement of the body structural elements such as the sidewalls 102. To aid in this maintenance operation, the hood 126 of the walk-in van body 100 extends the entire width of the front end of the walk-in van body 100, and is removable to provide complete access to the engine compartment of the vehicle. As may be seen from FIG. 13, even without the hood 126 removed, access to the engine compartment is maximized.

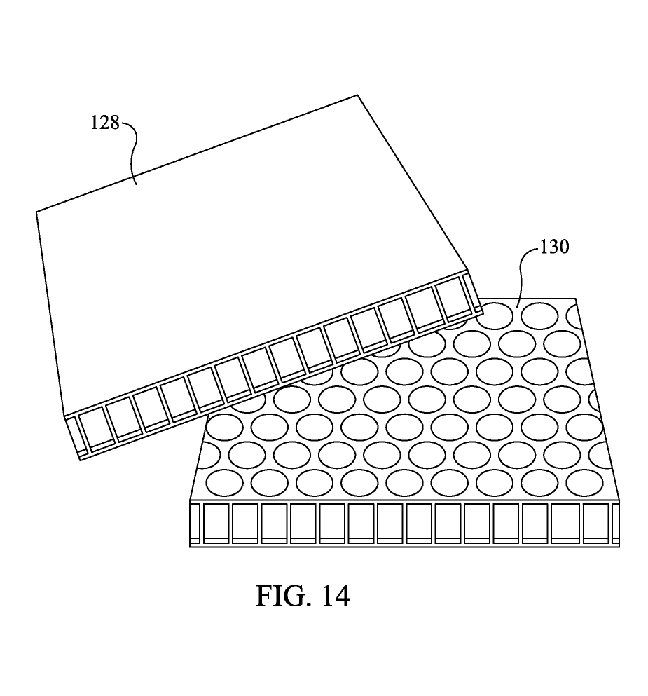

FIG. 14 illustrates a section of the sidewall composite structure 128 and the cargo floor composite structure 130 that allows the significant weight reduction, increase in corrosion resistance, and durability of the walk-in van body of the present invention. In the illustrated embodiment, the sidewall composite structure 128 is a 10 millimeter composite structure having a honeycomb core resin fusion, which may be made in the color desired by a particular customer. As may be seen from the cargo floor composite structure 130, at least the upper surface may be texture molded so as to provide a non-slip surface for the interior cargo compartment of the walk-in van. Further, since both the sidewall composite structure 128 and the cargo floor composite structure 130 are resin-fused composite structures, they resist corrosion caused by road salts and other chemical ice melters as used to melt snow and ice on roads and highways, unlike many prior metallic structures used for walk-in van body construction. Further, the cargo floor composite structure 130, the sidewalls 102, or both, can include reinforcing elements such as fiberglass cross beams for added support and strength.

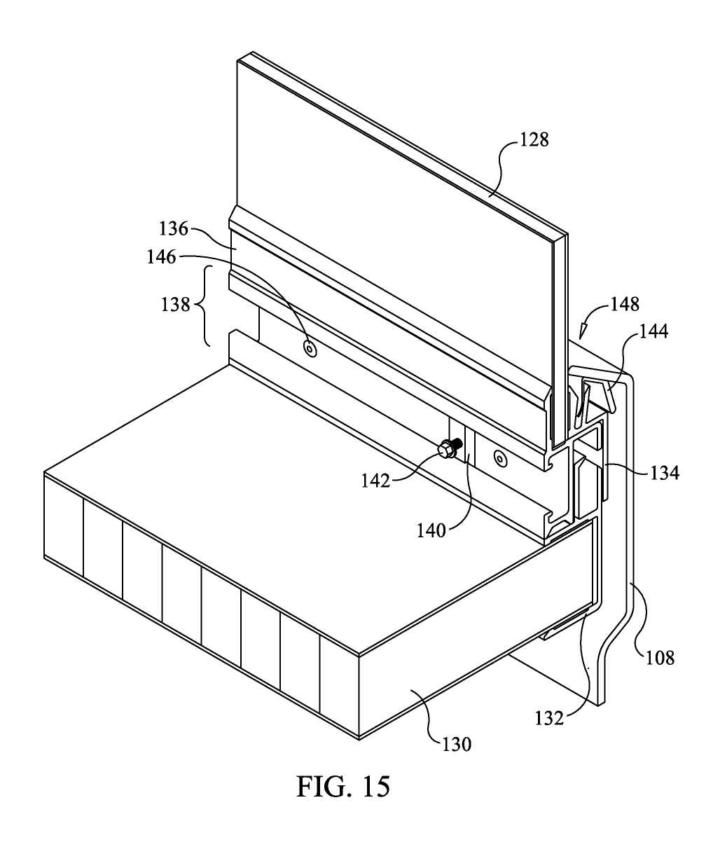

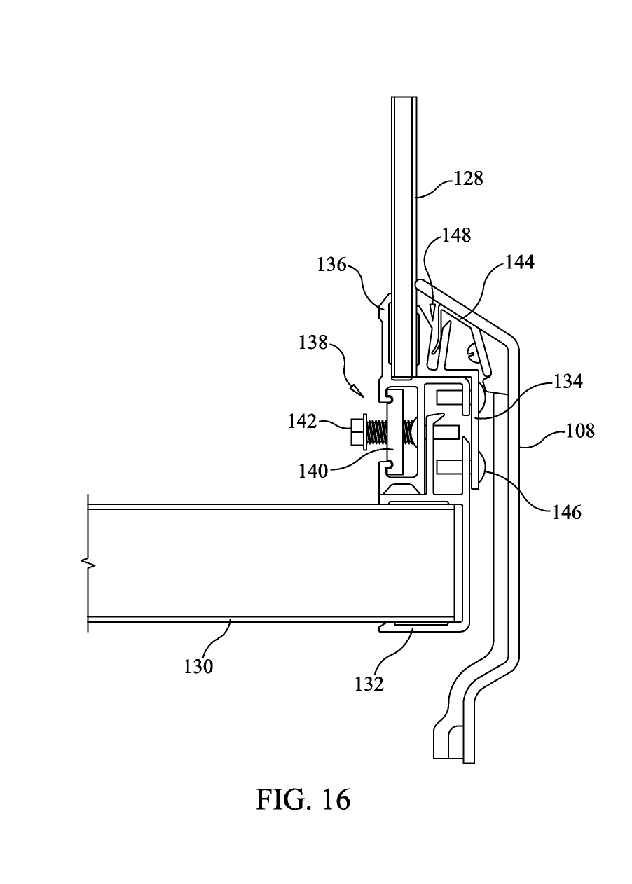

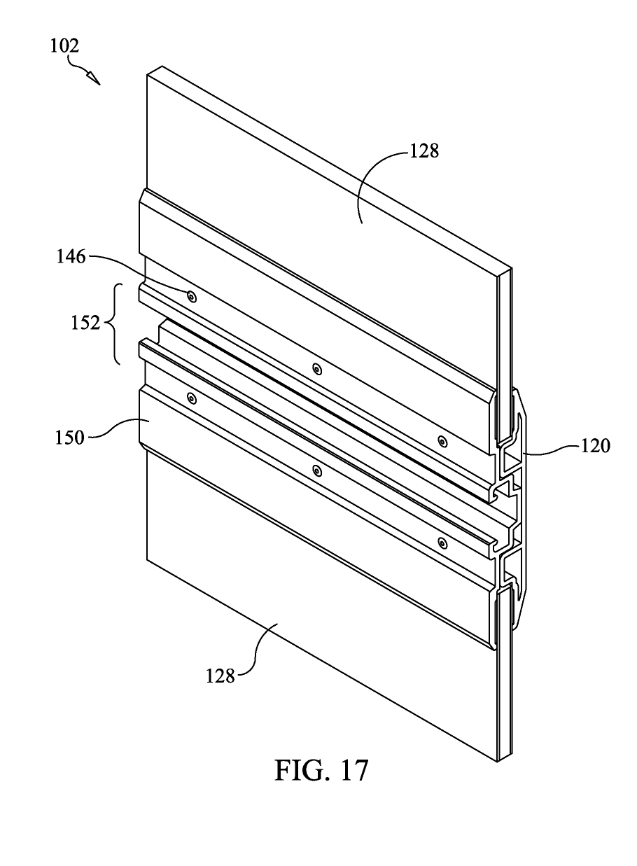

FIGS. 15 and 16 show the joining of the cargo floor composite structure 130 to the sidewall composite structure 128 in constructing the cargo area of the walk-in van body in accordance with one embodiment of the present invention. Specifically, the cargo floor composite structure 130 is affixed to the floor bracket 132 by an adhesive, which also acts as a sealant. The floor bracket 132 is joined to a sidewall exterior bracket 134 by rivets 146. The sidewall exterior bracket 134 is joined to a sidewall interior bracket 136, also by rivets 146. The coupling of the sidewall exterior bracket 134 and the sidewall interior bracket 138 forms a channel in which the sidewall composite structure 128 is affixed by an adhesive, which also serves as a sealant.

In addition to the sealing nature of the adhesive affixing the cargo floor composite structure 130 and the sidewall composite structure 128 in their respective brackets, the configuration of these brackets 132-136 ensure that none of the rivets 146 traverse a wet-to-dry barrier. In other words, the rivets 146 that connect the floor bracket 132 to the sidewall exterior bracket 134 traverse from the exterior of the vehicle into a pocket that is isolated from the actual cargo compartment of the walk-in van body. Additionally, rivets 146 that connect the sidewall interior bracket 136 to the floor bracket 132 traverse from the interior of the cargo compartment into the pocket formed between the floor bracket 132 and the sidewall exterior bracket 134. In this way, leak paths from the wet exterior to the dry interior are minimized if not eliminated.

Also as illustrated in these FIGS. 15-16, the body panels 108 are attached to the joining structure via a body panel fastener 144 that is received in a body panel fastener slot 148 formed as part of the sidewall exterior bracket 134. This allows for quick removal and replacement of the body panels 108 if damaged during operation as discussed above.

The sidewall interior bracket 134 is configured to form an integral logistic track 138 that runs along the entire length of the cargo compartment of the walk-in van. This logistic track 138 receives a logistic track fastener 140 that is secured in place by a logistic track fastener bolt 142. As will be recognized by those skilled in the art, the logistic track fastener 140 may be repositioned anywhere within the logistic track 138, and secured thereat by tightening the logistic track fastener bolt 142. To aid in holding the logistic track fastener in place during repositioning, a spring may also be included that spring loads the logistic track fastener 140 towards its engaged position so that it does not turn or otherwise fall out while being repositioned.

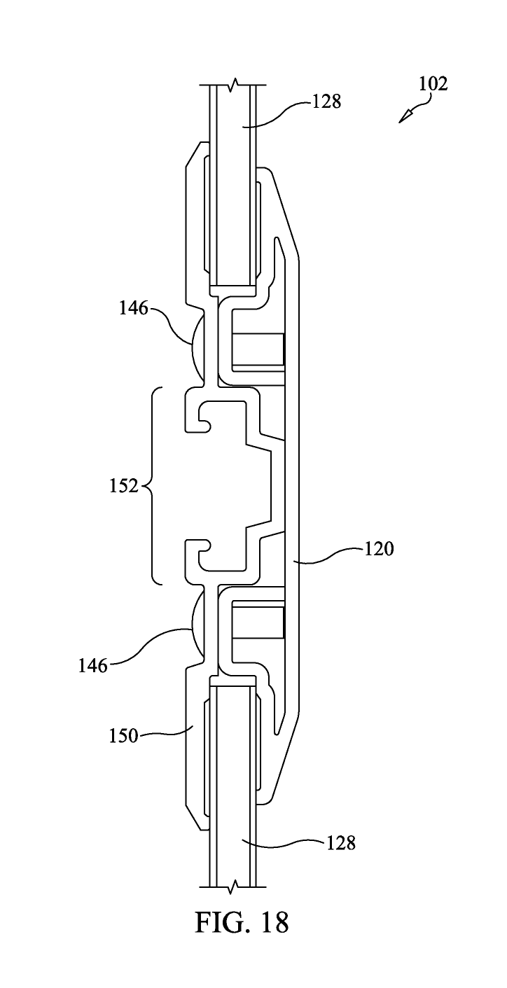

FIGS. 17 and 18 illustrate the construction of the sidewall 102 in accordance with an embodiment of the present invention. Specifically, the sidewall 102 and the illustrated embodiment utilizes two sidewall composite structures 128 to form a lower and upper portion of the sidewall separated by the rub rail 120. As may be seen, each of these two sidewall composite structures 128 are affixed in a channel formed between the rub rail interior bracket 150 and the rub rail 120 by an adhesive, that also acts as a sealant.

This rub rail interior bracket 150 is coupled to the rub rail 120 by rivets 146 that traverse from the dry cargo compartment into a pocket formed as part of the rub rail 120. As may be seen best from FIG. 18, this eliminates any leak path from a wet to a dry surface, thereby minimizing or eliminating the possibility of leaks from the wet exterior of the cargo compartment into the dry interior thereof.

As may also be seen in FIGS. 17 and 18, the rub rail interior bracket 150 is configured to form an integral rub rail logistic track 152 that traverses the entire sidewall of the cargo compartment of the walk-in van body in the illustrated embodiment. While not shown, a rub rail logistic track fastener is used to provide an attachment point to the sidewall 102 similarly as discussed above with regard to the logistic track 138.

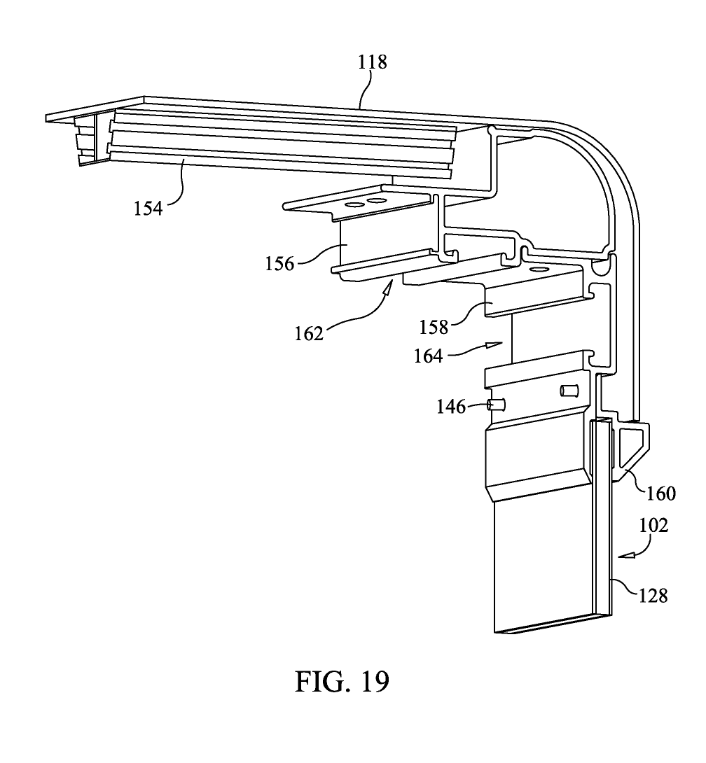

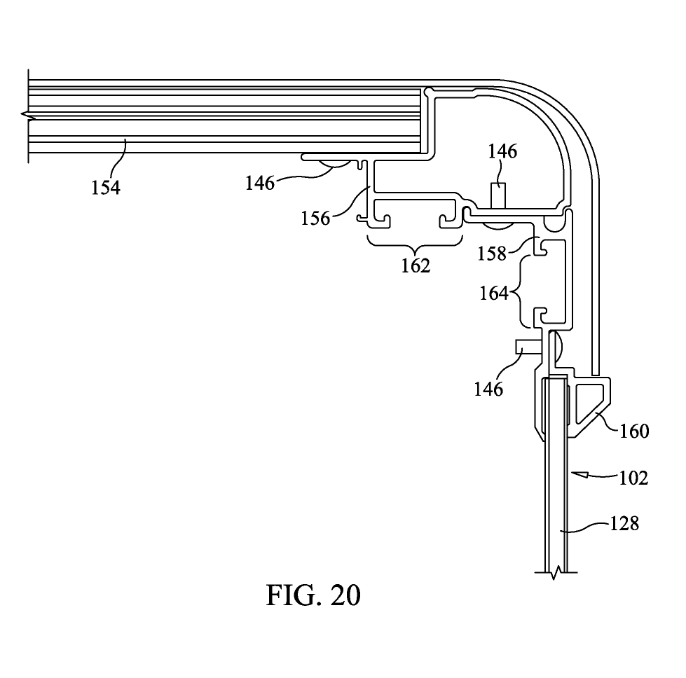

FIGS. 19 and 20 show the construction detail of the upper sidewall to roof coupling. As may be seen, the roof 118 is provided with additional structural rigidity from the roof support beams 154 that are attached via rivets 146 to the roof corner bracket 156. The roof corner bracket 156 is attached via rivets 146 to a roof/sidewall interior bracket 158 that, along with the roof/sidewall exterior bracket 160 attaches to the sidewall composite structure 128 forming the upper edge of the sidewall 102. As with the prior construction detail drawings, the rivets 146 utilized in the roof/sidewall construction also do not traverse from a wet to a dry surface.

As with the floor composite structure and the sidewall composite structures discussed above, the upper edge of the sidewall composite structure 128 is held in the slot formed between the roof/sidewall interior bracket 158 and the roof/sidewall exterior bracket 160 by an adhesive that also serves as a sealant. The single piece molded roof 118 is sealed via the use of a butyl rope that also forms a seal (not shown).

As may also be seen from FIGS. 19 and 20, the roof corner bracket 156 is configured to provide a ceiling logistic track 162 that may be used to configure the cargo area as desired by a particular user thereof. Similarly, the roof/sidewall interior bracket 158 is configured to provide an integral upper sidewall logistic track 164 that may also be used by a consumer to configure the interior of the cargo compartment as desired.

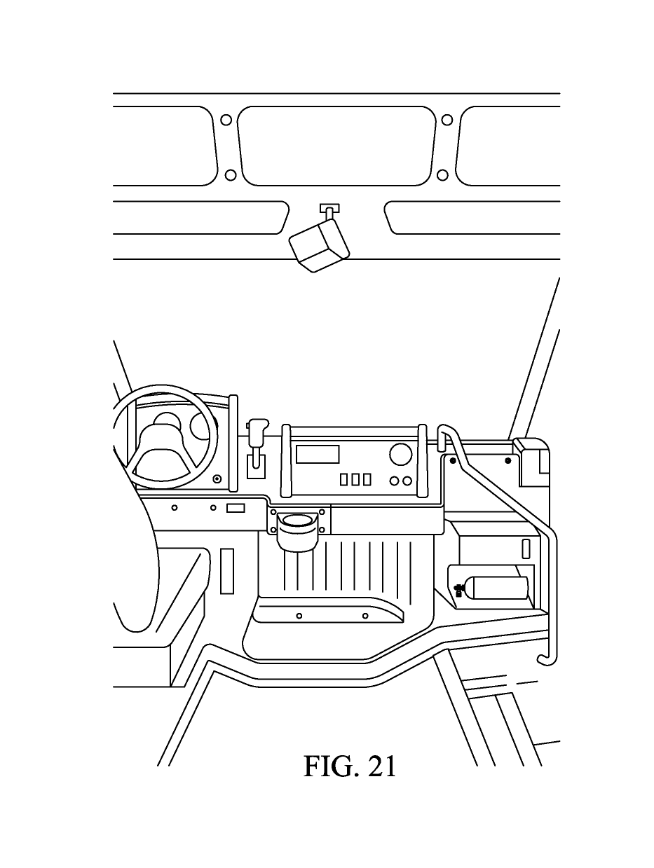

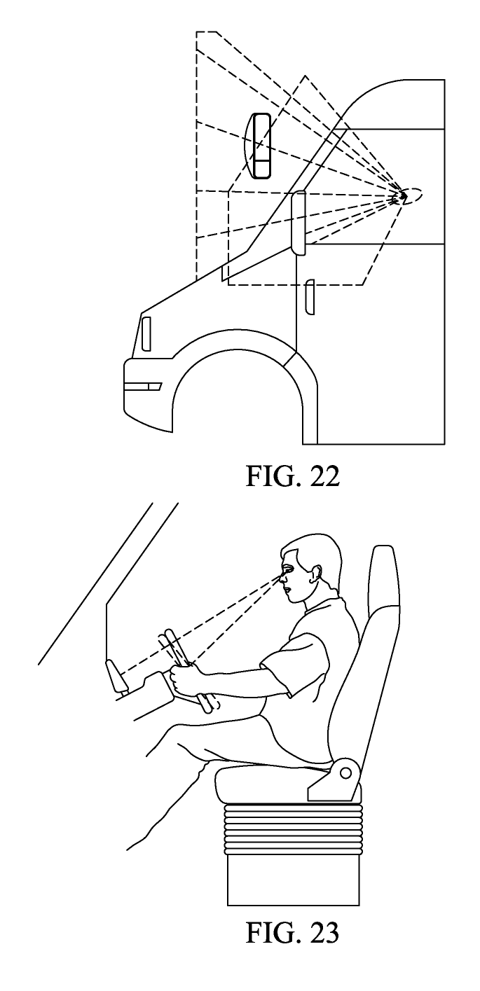

FIG. 21 illustrates a forward facing view of the cab area of one embodiment of the walk-in van body of the present invention. As introduced briefly above, many of the surfaces and components of the cab are molded or are SMC component to provide increased strength and durability with reduced weight. Driver safety and ergonomics are greatly enhanced by allowing driver movement in and around the cab area with enhanced visibility through a large slanted windshield (see FIG. 22) and with well-placed controls easily accessible and visible to the driver (see FIG. 23). Indeed, the design of the cab as an office greatly enhances the ergonomics and functionality of the cab by allowing the driver to walk in and out of the cab in an upright position and allowing access to cargo area from the driver seat. Driver safety is also enhanced by the placement of grab rails by the skid-proof steps that lead in and out of the passenger side of the cab.

FIG. 24 provides an additional view of this cab area illustrating the modular IP layout, simplified controls, and improved interior styling and fit and finish. Indeed, items that are routinely accessed by the driver are also brought within the cab, include the windshield washer fluid reservoir, being located above the fire extinguisher compartment, the fuse panel located beside the cup holder, and the brake fluid reservoir being located under the steering wheel and next to the driver side door. Switches for interior lights, the parking brake lever, gear shifter, and ignition switch are all placed in the cab within easy reach of the operator.

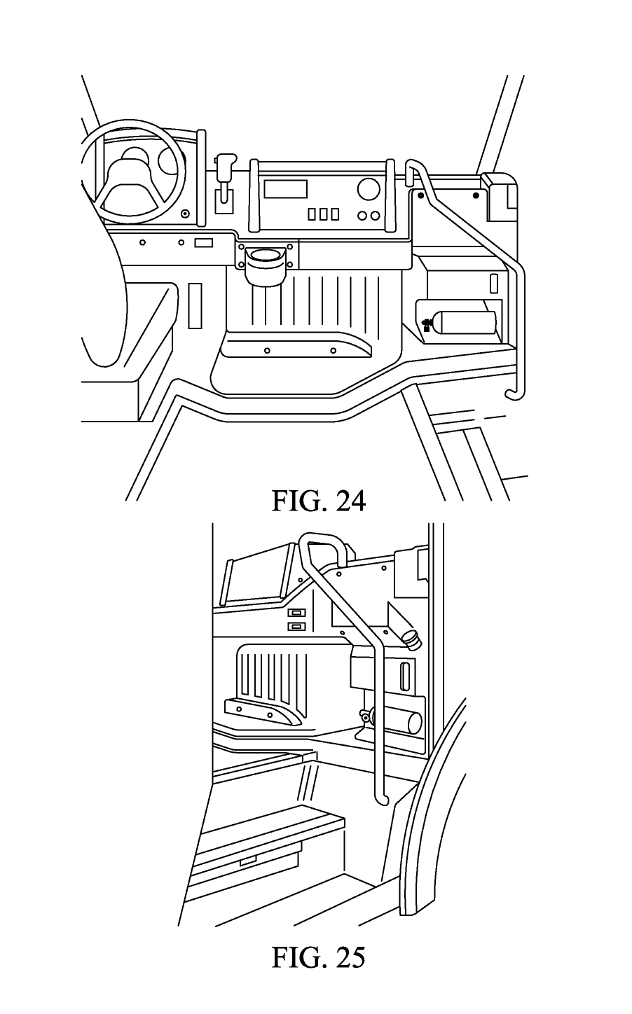

FIG. 25 provides another perspective of the cab area looking inward from the passenger side door. From this view, the washer fluid reservoir, handrail, and fire extinguisher are easily visible. Additionally, a tool kit is conveniently placed under the second step for easy access when needed.

FIG. 26 shows an operator in the driver seat looking into the cab from an open passenger door to illustrate the enhanced ergonomics and functionality provided by this embodiment of the present invention.

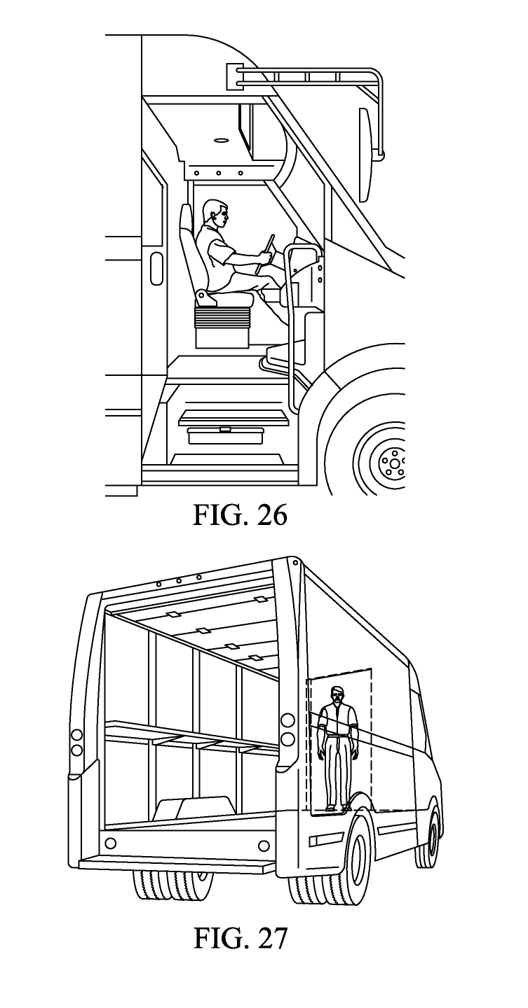

FIG. 27 illustrates one embodiment of a cargo area that demonstrates the enhanced ergonomics and functionality by allowing the operator to walk in and out of the cargo area both from the cab through a bulkhead doorway which can incorporate a slidable bulkhead door (not shown), as well as from the rear of the vehicle. Opening and closing of the bulkhead door can be automated through use of a key FOB or RFID carried by the operator, such as that shown and described in U.S. patent application Ser. No. 13/090,912 assigned to the instant assignee and herein incorporated by reference thereto in its entirety. The height of the cargo area also allows for the driver to move therein in a fully upright position, further enhancing the operability therein. As may be also seen from FIG. 27, embodiments of the present invention include spring loaded dock bumpers below the tail light on the rear body panels of the vehicle. Such spring loaded dock bumpers greatly enhance the durability of the vehicle and reduce damage that may otherwise be realized during operation of the walk-in van. In other embodiments, the rear bumper, which also serves as the step into the cargo area, may also be spring loaded to further increase the durability and reduce damage from rear impact, either from other vehicles or while the walk-in van is being backed into position for cargo loading or unloading at a dock or other facility.

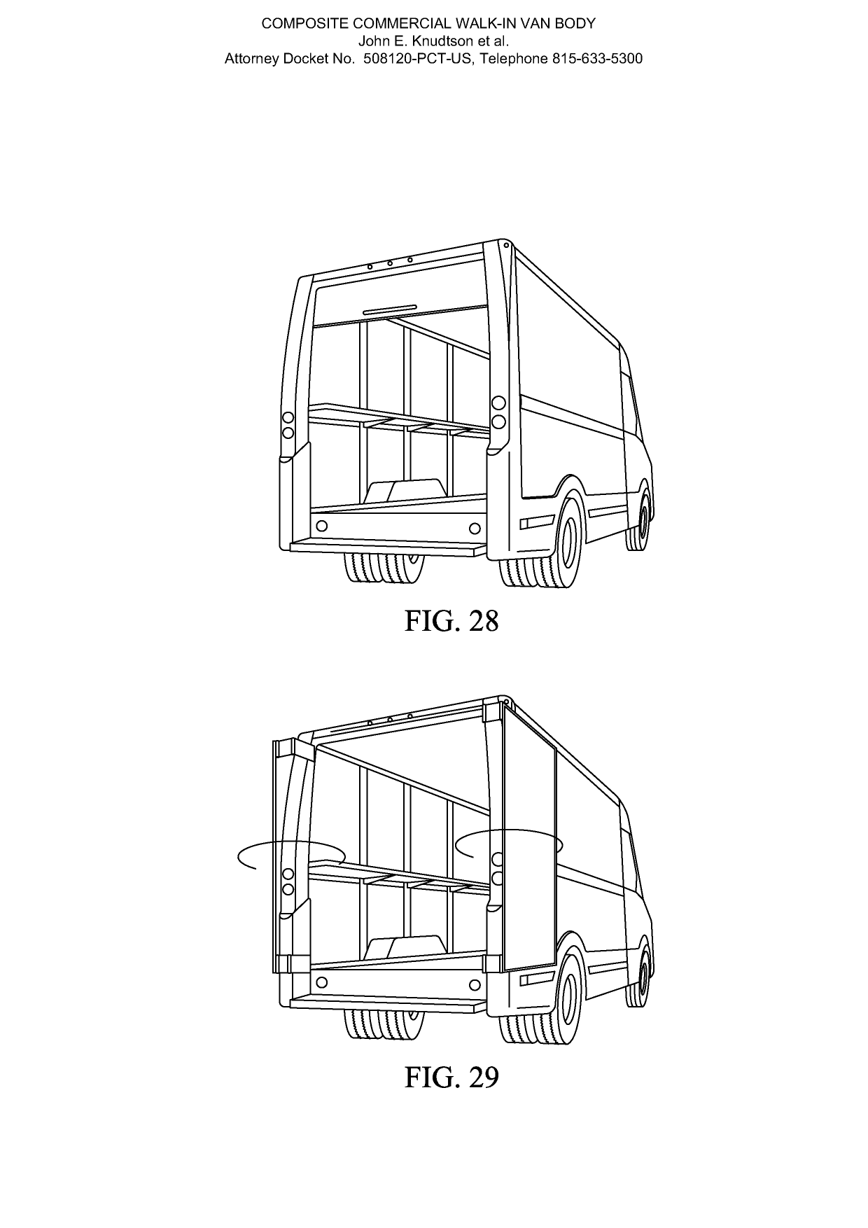

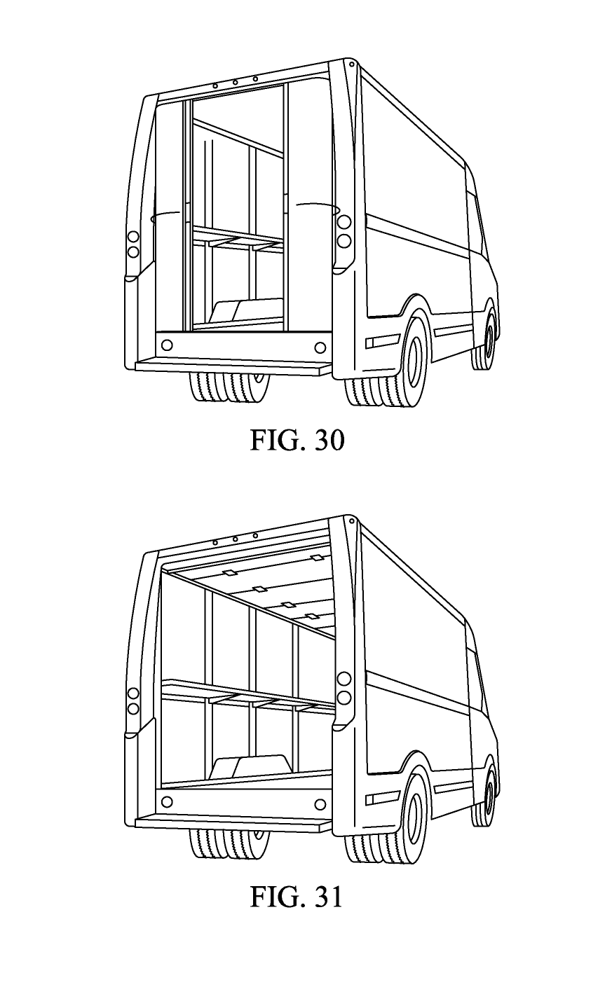

While previous embodiments discussed above included a roll-up rear door (see also FIGS. 28 and 31), multiple rear door options are available in different embodiments of the present invention. Indeed, the embodiment illustrated in FIG. 29 utilizes 270 degree twin-swinging doors to access the cargo area, while FIG. 30 illustrates the use of twin side-sliding doors.

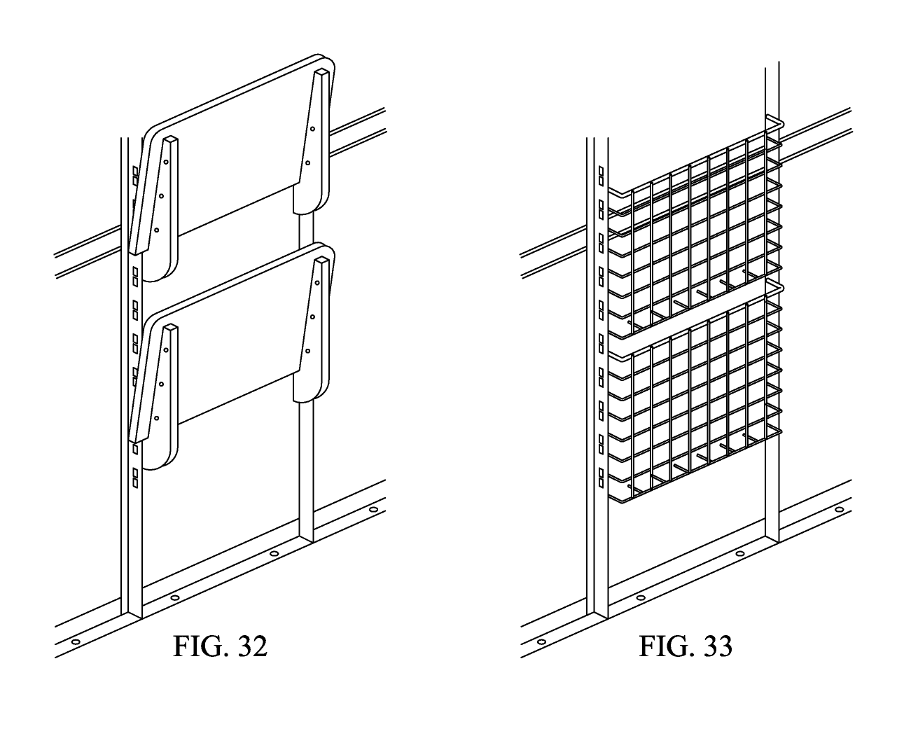

As discussed above, the inclusion of the integral logistic track within the cargo area allow for design flexibility within the cargo area. Such tracks enable the use of custom cargo interior packages or other package delivery cargo modules such as printer stands, spare tire mounts, hazardous good restraints, winter driving ballasts, etc. Indeed, FIG. 32 illustrates the installation of a shelving unit that is held in position by the logistic tracks, while FIG. 33 illustrates the inclusion of wire racks also held in position via an interface with the logistic tracks.

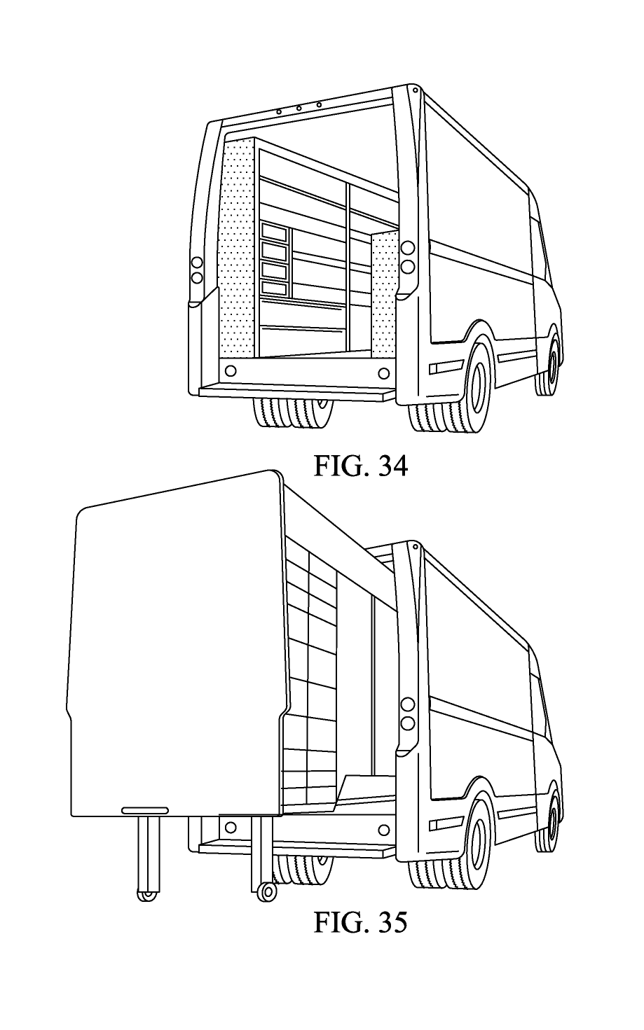

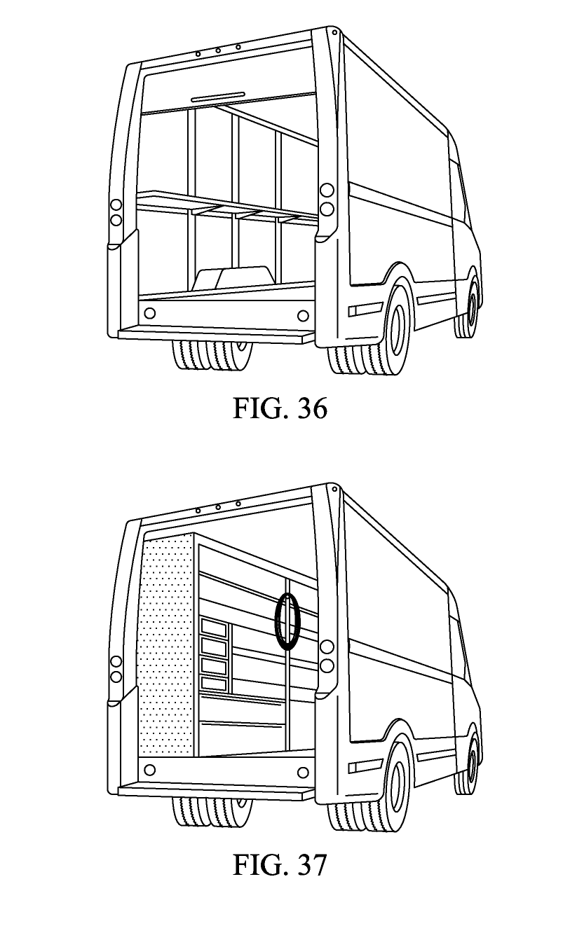

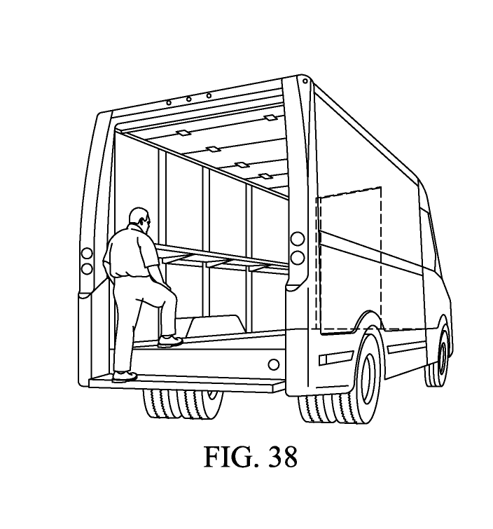

FIGS. 34-37 illustrate the great design flexibility as enabled by embodiments of the present invention. Specifically, the modular cargo area is designed for easy installation of custom vocational packages, such as those illustrated in FIGS. 34-37. Indeed, FIG. 38 illustrates the ease of ingress and egress into the cargo area not only for custom vocational packages, but also for operators. As may be seen from this FIG. 38, the cargo area is very clean and well laid out, with wiring harnesses for the rear lights and back-up camera (positioned in the top center of the body panel above the rear door) being buried within the ceiling logistic track and covered with an extruded cover to protect the wires therein. This allows for easy reconfiguration, while protecting the electrical and video system from inadvertent damage while moving cargo into and out of the cargo area. FIG. 38 also shows the inclusion of two integral logistic tracks in the floor of the cargo area (similar to the sidewall logistic tracks 152 shown in FIGS. 17 and 18). These floor logistic tracks also enhance the ability of an operator to configure the cargo compartment as desired or required for the particular cargo being hauled therein. While not shown, the mounting of the cargo area onto a vehicle frame may be accomplished through the use of body mounting pucks that provide isolation and dampening into the cargo area.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A composite commercial walk-in van body, comprising:
a cab; and
a cargo area adjoining the cab and accessible therethrough, the cargo area comprising:
a composite cargo floor;
a lower composite sidewall coupled to the composite cargo floor;
an upper composite sidewall coupled to the lower composite sidewall by a rubrail structure; and
a one-piece molded roof coupled to the upper composite sidewall.

2. The composite commercial walk-in van body of claim 1, wherein the composite cargo floor and the lower composite sidewall are coupled to one another via a lower bracket structure.

3. The composite commercial walk-in van body of claim 2, wherein the lower bracket structure is a multi-piece assembly comprising a floor bracket, a sidewall exterior bracket coupled to the floor bracket, and a sidewall interior bracket coupled to the sidewall exterior bracket.

4. The composite commercial walk-in van body of claim 3, wherein a portion of the composite cargo floor is received in a channel of the floor bracket.

5. The composite commercial walk-in van body of claim 4, wherein the portion of the composite cargo floor is fixed within the channel with an adhesive that acts as a sealant.

6. The composite commercial walk-in van body of claim 3, wherein the sidewall interior bracket and the sidewall exterior bracket are coupled to one another to form a channel, wherein a portion of the lower composite sidewall is received within the channel.

7. The composite commercial walk-in van body of claim 6, wherein the portion of the lower composite sidewall is fixed within the channel using an adhesive that acts as a sealant.

8. The composite commercial walk-in van body of claim 3, wherein the floor bracket includes an inner and an outer upstanding wall arranged in opposed spaced relation to form a pocket therebetween, wherein a portion of the sidewall exterior bracket and a portion of the sidewall interior bracket cover an opening of the pocket to isolate the pocket from an exterior environment of the van body.

9. The composite commercial walk-in van body of claim 8, wherein the sidewall exterior bracket is mounted to the outer upstanding wall using at least one outer rivet, and wherein the sidewall interior bracket is mounted to the inner upstanding wall using at least one inner rivet, wherein each of the at least one outer and inner rivets extend into the pocket formed between the inner and outer upstanding walls.

10. The composite commercial walk-in van body of claim 1, wherein the rubrail structure is a multi-piece structure comprising an interior bracket and a rubrail, wherein the interior bracket and rubrail are coupled to one another to form upper and lower channels, wherein the lower composite sidewall is received within the lower channel, and the upper composite sidewall is received within the upper channel.

11. The composite commercial walk-in van body of claim 10, wherein the lower composite sidewall is fixed within the lower channel with an adhesive that acts as a sealant, and wherein the upper composite sidewall is fixed within the upper channel with an adhesive that acts as a sealant.

12. The composite commercial walk-in van body of claim 10, wherein the rubrail includes at least one pocket which is isolated from an exterior of the van body, and wherein the interior bracket is joined to the rubrail using at least one rivet, wherein the at least one rivet extends into the at least one pocket of the rubrail.

13. The composite commercial walk-in van body of claim 1, wherein the one-piece molded roof is coupled to the upper sidewall via an upper bracket structure that is a multi-piece component comprising a corner bracket, a roof/sidewall interior bracket coupled to the corner bracket, and a roof/sidewall exterior bracket coupled to the roof/sidewall interior bracket.

14. The composite commercial walk-in van body of claim 13, wherein the corner bracket includes a channel for receiving at least one support beam positioned underneath the one-piece molded roof.

15. The composite commercial walk-in van body of claim 13, wherein the roof/sidewall interior bracket and roof/sidewall exterior bracket are coupled to one another to form a channel for receiving the upper sidewall.

16. The composite commercial walk-in van body of claim 15, wherein the upper sidewall is fixed within the channel with an adhesive that acts as a sealant.

17. The composite commercial walk-in van body of claim 13, wherein the one-piece molded roof is sealed to the upper bracket structure using a butyl rope.

18. The composite commercial walk-in van body of claim 1, wherein the composite cargo floor is formed from a corrosive resistant material and has an upper and a lower surface, the upper surface facing the cargo area, and the lower surface exposed to an exterior of the van body on an underside thereof.

19. The composite commercial walk-in van body of claim 18, wherein the composite cargo floor is a resin-infused, foam core construction having fiberglass cross beams, and wherein the upper surface is textured for slip resistance.

20. The composite commercial walk-in van body of claim 1 wherein the upper and lower sidewalls comprise a honeycomb core that is resin infused.

21. A composite commercial walk-in van body, comprising:
a cab having an interior operator space;
a cargo area adjoining the cab and accessible therethrough via a bulkhead doorway, wherein a bulkhead door is mounted within said doorway and slidable relative thereto; and
at least one vehicle fluid reservoir port, accessible from within the cab.

22. The composite commercial walk-in van body of claim 21, wherein the interior operator space has an overall height of about 5 feet to about 7 feet.

23. The composite commercial walk-in van body of claim 21, wherein the bulkhead door is mechanically coupled to an actuation mechanism, the actuation mechanism in electronic communication with a receiver, the receiver configured to receive an actuate signal to actuate the actuation mechanism and selectively and automatically open and close the bulkhead door.

24. A composite commercial walk-in van body, comprising:
a cab; and
a cargo area adjoining the cab and accessible therethrough, the cargo area comprising:
a cargo floor;
a lower sidewall coupled to the cargo floor by a lower bracket structure;
an upper sidewall coupled to the lower sidewall by a rubrail structure;
a roof coupled to the upper sidewall by an upper bracket structure; and
wherein at least one of the lower bracket structure, rubrail structure, and upper bracket structure comprises an integral logistic track formed therein.

25. The composite commercial walk-in van body of claim 24, wherein the integral logistic track comprises a raceway and a fastener slidable within the raceway, wherein the fastener is configured for adjustable fixed positioning within the raceway.

26. A method for assembling a composite commercial walk-in van body cargo area, comprising:
mounting a composite cargo floor to a lower bracket structure using an adhesive;
mounting a lower composite sidewall to the lower bracket structure using an adhesive at a first end of the lower composite sidewall;
mounting a rubrail structure to the lower composite sidewall at a second end opposite the first end of the lower composite sidewall using an adhesive;
mounting a first end of an upper composite sidewall to the rubrail structure using an adhesive;
mounting a second end of the upper composite sidewall to an upper bracket structure using an adhesive; and
sealingly installing a one-piece molded roof to the upper bracket structure.

27. The method of claim 26, further comprising assembling the lower bracket structure by forming a rivet connection between an interior sidewall bracket to a floor bracket and by forming a rivet connection between an exterior sidewall bracket to the floor bracket, wherein each of the rivet connections is isolated from an exterior of the cargo area.

28. The method of claim 26, further comprising assembling the rubrail structure by forming a rivet connection between an interior bracket and a rubrail, wherein the rivet connection is isolated from an exterior of the cargo area.

29. The method of claim 26, further comprising assembling the upper bracket structure by forming a rivet connection between a corner bracket and an interior roof/sidewall bracket and by forming a rivet connection between the interior roof/sidewall bracket and an exterior roof/sidewall bracket, wherein each of the rivet connections is isolated from an exterior of the cargo area.
